(19) United States
(12) Patent Application Publication
(10) Pub. No.: US 2020/0329748 A1
(43) Pub. Date: Oct. 22, 2020

(54) Novel Aspergillus oryzae CJ 1354 isolated from the Korean traditional meju, manufacturing method of a rice hot pepper paste using the same and the rice hot pepper paste prepared by the method

(71) Applicant: CJ Cheiljedang Corporation, Seoul (KR)

(72) Inventors: Seon Mi OH, Seoul (KR); Sung Hwan LIM, Gyeonggi-do (KR); Min Kyung PARK, Seoul (KR); Sun A CHO, Gyeonggi-do (KR); Eun Seok JANG, Gyeonggi-do (KR); Hye Won SHIN, Seoul (KR); Hyun Jun JANG, Gyeonggi-do (KR)

(21) Appl. No.: 16/923,323

(22) Filed: Jul. 8, 2020

Related U.S. Application Data
(63) Continuation of application No. 14/439,917, filed on Apr. 30, 2015, now abandoned.

(30) Foreign Application Priority Data
Oct. 31, 2012 (KR) 10-2012-0122714

(51) Int. Cl. A23L 7/10; C12R 1/69; A23L 7/104; A23L 11/00

(52) U.S. Cl. CPC A23L 7/1975; A23L 11/09; A23L 7/104; C12R 1/69

(57) ABSTRACT

The present invention relates to novel Aspergillus oryzae CJ 1354, isolated and identified from Korean traditional meju, exhibiting high enzymatic activities in rice as a substrate, a method for preparing a rice hot pepper paste having an improved flavor using the same, and a rice hot pepper paste prepared by the method. Specifically, the method comprises a process in which rice milled to have a certain whiteness is treated with high-pressure steam having a pressure of 2.0-4.0 kgf/cm² in a steaming step to control the viscosity and water content of the steamed rice to thereby prevent agglomeration from occurring during transfer of the steamed rice. Also, in the method, novel Aspergillus oryzae CJ 1354 is used in a step of making rice koji.

### BACKGROUND OF THE INVENTION

### Field of the Invention

The present invention relates to novel Aspergillus oryzae CJ 1354, manufacturing method of a rice hot pepper paste using the same, and the rice hot pepper paste prepared by the method.

More specifically, the present invention relates to novel Aspergillus oryzae CJ 1354, koji mold exhibiting excellent carbohydrase and protease activities in rice as a substrate, isolated and identified from Korean traditional meju, manufacturing method of a rice hot pepper paste having an improved flavor using the same, and the rice hot pepper paste prepared by the method.

### Description of the Prior Art

Generally, hot pepper paste is classified into traditional hot pepper paste prepared using meju for hot pepper paste made by mixing beans and grains at a specific ratio, and commercial hot pepper paste prepared using koji instead of meju for hot pepper paste.

Traditional hot pepper paste is prepared by soaking and steaming a starchy raw material, mixing the steamed material with a malt extract, saccharifying the mixture, and mixing the saccharified mixture with meju for hot pepper paste, hot pepper powder, table salt and the like, followed by fermentation and aging.

Commercial hot pepper paste is prepared by soaking a starchy raw material or adding water thereto, steaming the soaked or water-added material, mixing the steamed material with table salt, koji obtained by culture of Koji mold, and the like, aging the mixture, and mixing the aged material with starch sugar, hot pepper powder and the like. As the starchy material, wheat flour or polished wheat has been mainly used, which are advantageous in terms of the raw material supply, cost, and processability of raw material suitable for mass production. However, in recent years, due to mass production methods designed in view of the high viscosity characteristic of rice, the use of rice as the raw material has greatly increased.

Rice shows increased surface viscosity after gelatinization compared to wheat flour or polished wheat, and thus causes transfer problems and an agglomeration phenomenon of raw material. This agglomeration phenomenon adversely affects the growth of Koji mold such as Aspergillus oryzae, and thus rice koji having low enzyme activity and large quality deviation is prepared. A rice hot pepper paste including such rice koji has a low quality level, and is difficult to produce in large amounts because the quality thereof is difficult to maintain at a constant level.

As a prior art methods that allowed for the mass production of commercial hot pepper paste using rice and improve the quality of hot pepper paste, Korean Patent Laid-Open Publication No. 10-2011-0017619 discloses a method for preparing a koji for rice hot pepper paste, which has high enzyme activity and is used to improve the flavor of rice hot pepper paste. The disclosed method comprises steaming rice raw material, milled to grade 4 to grade 12, to have a water content of 30-32 wt %, humidifying the steamed rice to have a water content of 35-38 wt % and controlling the temperature 30-38° C. to prevent the growth retardation of Koji mold by delaying the rate of aging of gelatinized rice, thereby providing koji having high enzyme activity.

However, in the prior art method as described above, the viscosity of the rice surface can be somewhat reduced, but there are problems in that, as the degree of milling of rice decreases, the fiber content of the rice increases, the rate of degradation of the rice by Koji mold decreases, and for this reason, the growth of Koji mold is reduced so that the enzyme activity of koji will decrease. In addition, there is a problem in that the texture of hot pepper paste decreases.

The present inventors have made efforts to solve the above-described problems occurring in the prior art, and have found that, when rice milled to have a specific whiteness is treated with high-pressure steam having a pressure of 2.0-4.0 kgf/cm² in a steaming step, problems arising during the transfer of the raw material are solved and the texture of hot pepper paste is improved. Also, the present inventors have isolated and identified novel Aspergillus oryzae CJ 1354, which uses rice as a substrate and shows high enzymatic activity, from Korean traditional meju, and have developed a method of preparing a rice hot pepper paste having a better flavor using the isolated novel strain, and a rice hot pepper paste prepared by the method, thereby completing the present invention.

### SUMMARY OF THE INVENTION

It is an object of the present invention to isolate and identify novel Aspergillus oryzae CJ 1354, exhibiting excellent carbohydrase and protease activities in rice as a substrate, from Korean traditional meju, and provide a method of preparing a rice hot pepper paste having a better flavor using the same, and a rice hot pepper paste prepared by the method.

Specifically, it is an object of the present invention to provide a method for preparing a rice hot pepper paste having an excellent flavor, in which rice milled to have a specific whiteness is treated with high-pressure steam having a pressure of 2.0-4.0 kgf/cm² in a steaming step to control the viscosity and water content of the steamed rice to thereby prevent an agglomeration phenomenon from occurring during the transfer of the rice, and novel Aspergillus oryzae CJ 1354, isolated and identified from Korean traditional meju, which exhibits high enzyme activity in rice as a substrate, is used in a step of preparing rice koji, and a rice hot pepper paste prepared by the method.

To achieve the above object, the present invention provides novel Aspergillus oryzae CJ 1354 isolated and identified from Korean traditional meju, which shows high carbohydrase and protease activities in rice as a substrate.

The present invention also relates to a method for preparing a rice hot pepper paste using novel Aspergillus oryzae CJ 1354, and provides a method for preparing a rice hot pepper paste, the method comprising the steps of: soaking rice or adding water to rice, and steaming the soaked or water-added rice; inoculating and culturing Aspergillus oryzae CJ 1354 in the steamed rice to make rice koji; adding salt water to the rice koji, mixing therewith at least one selected from the group consisting of steamed rice, a processed bean product, Korean traditional meju and Korean traditional doenjang, to obtain a first mixture, and aging the first mixture; and adding hot pepper powder to the aged first mixture, mixing therewith at least one selected from the group consisting of starch sugar, soy sauce, a spice product, a flavor enhancer and a processed grain product, to obtain a second mixture, and aging the second mixture.

The present invention also provides a rice hot pepper paste prepared by the above method.

### BRIEF DESCRIPTION OF THE DRAWINGS

FIG. 1 is a phylogenetic tree of novel Aspergillus oryzae CJ 1354.

FIG. 2 shows the results of analyzing the 16S rDNA nucleotide sequence of novel Aspergillus oryzae CJ 1354.

### DETAILED DESCRIPTION OF THE INVENTION

The present invention relates to novel Aspergillus oryzae CJ 1354 isolated and identified from Korean traditional meju, which shows high carbohydrase and protease activities in rice as a substrate.

Aspergillus oryzae CJ 1354 was isolated and identified from Korean traditional meju collected from Korean traditional food manufacturers.

In the isolation and identification method, 6 Aspergillus oryzae strains were selected among fungi isolated from Korean traditional meju which have high spore-producing ability and produce no toxin and cause no allergy. The selected strains can be used as Koji mold. Then, among the selected strains, strains showing strong carbohydrase and protease activities during solid culture using rice as a substrate were selected. The finally selected strain was named Aspergillus oryzae CJ 1354, and deposited in the Korean Culture Center of Microorganisms on Sep. 27, 2012 (accession number: KCCM 11300P).

The present invention also relates to a method of preparing rice hot pepper paste by fermenting steamed rice using Aspergillus oryzae CJ 1354.

More specifically, the present invention provides a method for preparing a rice hot pepper paste, the method comprising the steps of: (1) soaking rice or adding water to rice, and steaming the soaked or water-added rice; (2) inoculating and culturing Aspergillus oryzae CJ 1354 in the steamed rice to make rice koji; (3) adding salt water to the rice koji, mixing therewith at least one selected from the group consisting of steamed rice, a processed bean product, Korean traditional meju and Korean traditional doenjang, to obtain a first mixture, and aging the first mixture; and (4) adding hot pepper powder to the aged first mixture, mixing therewith at least one selected from the group consisting of starch sugar, soy sauce, a spice product, a flavor enhancer and a processed grain product, to obtain a second mixture, and aging the second mixture.

In the method for preparing rice hot pepper paste according to the present invention, rice that is used in step (1) as a raw material preferably has a whiteness of 28-45. As the whiteness increases, the amount of surface fiber is small, and thus Koji mold more easily penetrates into the inside of rice grains during koji preparation, the enzymatic activity of koji is high, and the texture of hot pepper paste is good, whereas difficulty in a transfer process occurs. As the whiteness decreases, it is more advantageous for transfer of rice, but the amount of surface fiber is large, and thus Koji mold is difficult to penetrate into the inside of rice grains, and hyphae do not properly spread. For these reasons, in view of the easy penetration of Koji mold into rice grains, the degradation rate of grains by the enzymes, the texture of hot pepper paste, and the easy transfer of steamed rice, rice having a whiteness of 28-45, a standard suitable for mass production, is preferably used.

Rice having the above-described whiteness is soaked in water for a certain time, or a certain amount of purified water is added to the rice. Next, the soaking water or purified water is primarily discharged, and then discharged using high-pressure steam having a pressure of 2.0-4.0 kgf/cm².

Next, the rice is steamed with saturated steam (1.0 kgf/cm²) at a temperature of 80 to 110° C. for 15 minutes to 1 hour, and then cooled to a temperature of 30 to 40° C. to control the water content of the steamed rice to 25-35 wt %.

In the method for preparing rice hot pepper paste according to the present invention, step (2) is a step of inoculating and culturing Aspergillus oryzae CJ 1354 in the steamed rice to prepare koji. Specifically, in step (2), based on the total weight of the raw materials, 0.1-0.3 wt % of Aspergillus oryzae CJ 1354 and 0.5-1.5 wt % of grain powder or bean powder as a bulking agent are mixed uniformly with the steamed rice, and then the rice is fermented at a temperature of 33 to 40° C., preferably 35 to 40° C., for 3 days, to prepare rice koji.

In the method for preparing rice hot pepper paste according to the present invention, step (3) is a step of adding salt water to the rice koji, mixing therewith at least one selected from the group consisting of steamed rice, processed bean products, Korean traditional meju and Korean traditional doenjang, to obtain a first mixture, and aging the first mixture.

The salt water may preferably be added in an amount of 15-25 wt % based on the total weight of the first mixture.

When the steamed rice is added, it may be added in an amount of 5-15 wt % based on the total weight of the first mixture.

The term “processed bean product” means a processed product containing beans as a main material, and meju or doenjang is not specifically limited, and may be any known product.

At least one selected from the processed bean product, meju and doenjang may be added in an amount of 3-15 wt % based on the total weight of the first mixture.

Meanwhile, in order to enhance the flavor of the hot pepper paste, a yeast culture may optionally be added to the first mixture. Yeast that may be used in the present invention is not specifically limited, and may be, for example, a strain belonging to the genus Saccharomyces, the genus Zygosaccharmyces or the genus Pichia.

Preferably, the first mixture may contain water in an amount of 43-53 wt % based on the total weight of the first mixture.

In addition, the first mixture may be subjected to a chopping process before aging.

The term “chopping process” process means a process of chopping the first mixture to a material having a smaller size. The size to which the first mixture is chopped is not specifically limited, but is preferably greater than 0 mm to not greater than 20 mm (based on the inner diameter of amorphous particles in the first mixture), more preferably 1-10 mm, and most preferably 1-5 mm.

When the first mixture is subjected to the chopping process before aging, enzymes can easily penetrate up to the core of the grains to produce more diverse tastes and flavors, and the aging time can be shortened, and the sensory properties of the hot pepper paste can also be improved.

The first mixture is preferably fermented and aged at a temperature of 25 to 35° C. for 15-30 days.

In the method for preparing rice hot pepper paste according to the present invention, step (4) is a step of adding hot pepper powder to the aged first mixture, mixing therewith at least one selected from the group consisting of starch sugar, soy sauce, spice products, flavor enhancers and processed grain products, to obtain a second mixture, and aging the second mixture.

Specifically, hot pepper powder is added to the aged first mixture, and then at least one selected from the group consisting of starch sugar, soy sauce, spice products, flavor enhancers and processed grain products is mixed therewith to obtain a second mixture. The second mixture is sterilized at a temperature of 55 to 85° C. for 1-60 minutes, and then edible alcohol is added, followed by aging.

The hot pepper powder may be added in an amount of 6-25 wt % based on the total weight of the second mixture, and at least one selected from the group consisting of starch sugar, soy sauce, spice products, flavor enhancers and processed grain products is preferably added in an amount of 15-40 wt % based on the total weight of the second mixture.

The above-mentioned hot pepper powder, starch sugar, soy sauce, spice product, flavor enhancer and processed grain product that are used in the present invention are not specifically limited, and may be known products.

Non-limiting examples of the spice product include dried minced spices and wet minced spices.

The non-limiting examples of the flavor enhancer include yeast extracts, bean extracts, and wheat protein extracts.

As described above, in the method for preparing rice hot pepper paste according to the present invention, the process of treating rice (milled to have a certain whiteness) with high-pressure steam having a pressure of 2.0-4.0 kgf/cm² in the steaming step (step 1) is performed. This process has the effect of controlling the viscosity and water content of the steamed rice, thereby preventing the raw material from agglomerating during transfer.

In addition, in the method for preparing rice hot pepper paste according to the present invention, a rice hot pepper paste having an improved flavor can be prepared by using novel Aspergillus oryzae CJ 1354 that uses rice as a substrate and shows high carbohydrase and protease activities.

Hereinafter, the present invention will be described in further detail with reference to examples. However, these examples are provided for a better understanding of the present invention, and the scope of the present invention is not limited to these examples.

1. Isolation, Identification and Selection of Microorganisms from Korean Traditional Meju

1) Isolation and Identification of Microorganisms

Strains used as starters in the present invention were isolated and identified from Korean traditional food manufacturers located in Gyeonggi-do, Gangwon-do, Chungcheongbuk-do and Jeollanam-do, Korea.

As a medium for isolation of fungi, potato dextrose agar (Difco) medium supplemented with 20 μg/ [symbol] chloramphenicol was used. 32 fungi present as dominant species the Korean traditional meju were isolated and identified, and the results of the identification are shown in Table 1 below.

2) First Selection

Among the above-described 32 fungal strains isolated from Korean traditional meju, 6 fungal strains were primarily selected based on the comprehensive assessment of the potential of use as Koji mold, such as spore-producing ability.

The primarily selected strains were CJ 1334, CJ 1335, CJ 1336, CJ 1354, CJ KY and CJ KG, and the results of assessing the spore-producing abilities thereof are shown in Table 1 below.

TABLE 1
Results of identification of strains isolated from Korean
traditional meju and spore-producing ability of each strain

| | | Spore- | |
|---|---|---|---|
| Strain | Results | producing | |
| No. | of identification | ability | Remarks |
| CJ 1333 | Aspergillus oryzae | ** | |
| CJ 1334 | Aspergillus oryzae | *** | |
| CJ 1335 | Aspergillus oryzae | *** | |
| CJ 1336 | Aspergillus oryzae | *** | |
| CJ 1337 | Aspergillus flavus | * | Produced toxin |
| CJ 1338 | Aspergillus niger | *** | |
| CJ 1339 | Aspergillus flavus | * | Produced toxin |
| CJ 1340 | Aspergillus tubingensis | *** | Aspergillus niger |
| CJ 1341 | — | x | Not produce |
| | | | spore |
| CJ 1342 | Aspergillus sydowii | ** | |
| CJ 1343 | Penicillium polonicum | * | |
| CJ 1344 | Mucor racemosus | ** | |
| CJ 1345 | Penicillium polonicum | * | Caused allergy |
| CJ 1346 | Mucor racemosus | *** | |
| CJ 1347 | Penicillium polonicum | * | |
| CJ 1348 | Emericella nidulans | * | Caused allergy |
| CJ 1349 | Talaromyces spectabilis | ** | |
| CJ 1350 | Emericella rugulosa | ** | Caused allergy |
| CJ 1351 | Mucor racemosus | *** | |
| CJ 1352 | Emericella dentata | * | Caused allergy |
| CJ 1353 | Mycocladus corymbiferus | *** | |
| CJ 1354 | Aspergillus oryzae | *** | |
| CJ 1355 | Mycocladus corymbiferus | *** | |
| CJ 1356 | Aspergillus flavus | *** | Produced toxin |
| CJ 1357 | Absidia corymbifera | * | |
| CJ 1358 | Aspergillus oryzae | ** | |
| CJ 1359 | Aspergillus oryzae | ** | |
| CJ 1360 | Aspergillus vadensis | ** | |
| CJ 1361 | — | * | |
| CJ 1362 | — | * | |
| CJ KY | Aspergillus oryzae | *** | |
| CJ KG | Aspergillus oryzae | *** | |

3) Second Selection

Using the six strains in the first selection, rice koji were prepared, and the amylase and protease activities were compared therebetween. A strain having high amylase and protease activities was selected in the second selection.

To prepare rice koji, 1 kg of rice was soaked in purified water for 30 minutes, and then steamed in an autoclave at 110° C. for 15 minutes, followed by cooling to 35° C. To the cooled steamed rice, each of the strains selected in the first selection step was added in an amount of 0.2 wt % based on the weight of the raw material, and then cultured at 35° C. for 3 days. The enzymatic activities of each rice koji are shown in FIG. 2 below.

From the results in Table 2, a CJ 1354 strain having the highest amylase and protease activities was selected.

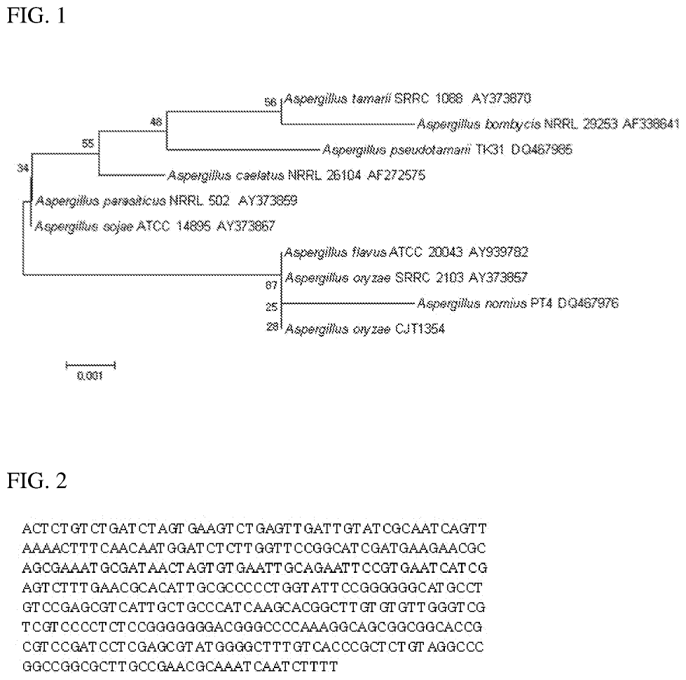

A phylogenetic tree of the Aspergillus oryzae CJ 1354 finally selected in the second step is shown in FIG. 1.

In addition, the results of analyzing the 16S rDNA nucleotide sequence of CJ 1354 are shown in FIG. 2.

TABLE 2
Comparison of enzymatic activities between rice kojis
prepared using strains selected in first selection step

| | Amylase activity (U/g) | Protease activity (U/g) |
|---|---|---|
| CJ 1334 | 511 | 68 |
| CJ 1335 | 511 | 66 |
| CJ 1336 | 478 | 62 |
| CJ 1354 | 632 | 69 |
| CJ KY | 514 | 69 |
| CJ KG | 511 | 64 |

In order to measure the amylase enzyme activity as shown in Table 2 above, the rice koji was extracted in 2% NaCl aqueous solution at 30° C. for 1 hour, and filtered to obtain a crude extract solution, which was then diluted 100-fold. An enzyme reaction solution was prepared by mixing 1 [symbol] of the crude enzyme solution, 2 [symbol] of 1% starch sugar as a substrate and 2 [symbol] of phosphate buffer (pH 5.2). The reaction solution was allowed to react at 40° C. for 30 minutes, and then 10 [symbol] of 0.1N CH₃COOH was added thereto to stop the reaction. After completion of the reaction, the enzyme reaction solution was developed by addition of 10 [symbol] of 0.005% KI+I₂ solution at room temperature, and the absorbance at 660 nm was measured using a UV spectrophotometer.

To measure the protease enzyme activity, the rice koji was extracted in distilled water at 30° C. for 1 hour, and then filtered to obtain a crude enzyme solution. An enzyme reaction was prepared by mixing 0.5 [symbol] of the crude enzyme solution, 1.5 [symbol] of 2% milk casein as a substrate and 1 [symbol] of Mcllvaine buffer (pH 6.0), and allowed to react at 38° C. for 1 hour. Next, 3 [symbol] of 0.4M TCA solution was added thereto to stop the reaction, followed by filtration. Next, 5 [symbol] of 0.4M Na₂CO₃ and 1 of [symbol] of phenol reagent were added to and sufficiently mixed with the filtrate, and the mixture was developed at 38° C. for 30 minutes. The absorbance at 660 nm was measured using a UV spectrophotometer. Regarding the enzyme activity, the amount of the enzyme, which produced 1 μg of tyrosine for 1 min, was defined as one unit, and a calibration curve was plotted using tyrosine as a standard.

2. Preparation of Hot Pepper Paste

1) Steaming Step

In order to overcome the transfer problem arising after rice steaming and improve the texture of hot pepper paste, a high-pressure steam treatment process as described in Example 1 below was performed. In Comparative Example 1, the high-pressure steam treatment process was not performed.

Rice having a whiteness of 35 corresponding to a high milling degree was used in order to improve the texture of hot pepper paste.

### Example 1: Rice Steaming Including High-Pressure Steaming Process

Rice having a whiteness of 35 was put in a steamer, and based on the weight of the rice, 75 wt % of purified water was added to the steamer. The rice was steamed for 35 minutes after the addition of purified water, and then the soaking water was discharged at atmospheric pressure. After discharge of the soaking water, the rice was treated with high-pressure steam (2.0 kgf/cm²), and condensed water and the remaining soaking water were discharged for 30 minutes.

After the rice was treated with high-pressure steam, it was steamed with saturated steam (1.0 kgf/cm²) at 90° C. for 45 minutes, and then cooled to 35° C.

The physical properties of the steamed rice obtained after the steaming step including high-pressure steam treatment are shown in Table 3 below.

### Comparative Example 1: Rice Steaming without High-Pressure Steam Treatment

Rice having a whiteness of 35 was put in a steamer, and based on the weight of the rice, 75 wt % of purified water was added to the steamer. The rice was steamed for 35 minutes after the addition of purified water, and then the soaking water was discharged. After discharge of the soaking water, the rice was steamed with saturated steam (1.0 kgf/cm²) at 90° C. for 45 minutes, and then cooled to 35° C.

The physical properties of the rice not treated with high-pressure steam are shown in Table 3 below.

TABLE 3
Comparison of physical properties of steamed rice between inclusion
and non-inclusion of high-pressure steam treatment process

| | Water content | | |
|---|---|---|---|
| | (%) | Adhesiveness | Stickiness |
| Example 1 | 32 | 2.28 | 1.34 |
| Comparative | 35 | 3.84 | 3.61 |
| Example 1 | | | |

In Table 3 above, “adhesiveness” means a numerical value obtained by measuring the instantaneous adhesion of the adhesive portion of the outer surface of grains, and “stickiness” means a numerical value obtained by the continuous adhesion of the adhesive portion of the outer surface of grains. In order to measure these values, steamed grains were wrapped airtight in containers, and in this state, the grains were allowed to cool at 30° C. for 1 hour and well mixed. Then, 10 g of the grains were placed in each TA dish, and pressed with a press to make the surface uniform. Next, the physical properties of the grains were repeatedly measured 10 times with the program of a texture analyzer (Takemoto, Japan), and the measurements were averaged, excluding the highest and lowest values.

From the results in Table 3 above, it was shown that the water content, adhesiveness and stickiness of the steamed rice of Example 1 that includes treatment with high-pressure steam having a pressure of 2.0 kgf/cm² were improved, suggesting that the agglomeration of the steamed rice was inhibited.

2) Koji Preparation

Each of the finally selected strain Aspergillus oryzae CJ 1354 and commercially available Aspergillus oryzae was inoculated and cultured in the steamed rice of Example 1 as described in Example 2 and Comparative Example 2 to prepare rice kojis. The enzymatic activities of the rice kojis were compared.

### Example 2: Preparation of Rice Koji Using Novel Aspergillus oryzae CJ 1354

The rice steamed in Example 1 was cooled during its transfer to a koji preparing room. The cooled rice was treated with saturated steam (1.0 kgf/cm²) at 1-hour intervals to supplement the outer surface and inside of the rice with water. Then, 0.2 wt % of novel Aspergillus oryzae CJ 1354 was inoculated into the rice and fermented at 38° C. for 3 days to make koji.

The enzymatic activity of the rice koji prepared using novel Aspergillus oryzae CJ 1354 is shown in Table 4 below.

### Comparative Example 2: Preparation of Rice Koji Using Conventional Aspergillus oryzae

The rice steamed in Example 1 was cooled during its transfer to a koji making room. The cooled rice was treated with saturated steam (1.0 kgf/cm²) at 1-hour intervals to supplement the outer surface and inside of the rice with water. Then, 0.2 wt % of conventional Aspergillus oryzae was inoculated into the rice and fermented at 38° C. for 3 days to make koji.

The enzymatic activity of the rice koji prepared using conventional Aspergillus oryzae is shown in Table 4 below.

TABLE 4
Enzymatic activities of the rice koji prepared using
novel Aspergillus oryzae CJ 1354 and the rice
koji prepared conventional Aspergillus oryzae

| | Amylase activity (U/g) | Protease activity (U/g) |
|---|---|---|
| Example 2 | 323.2 | 53.7 |
| Comparative Example 2 | 276.0 | 48.0 |

As can be seen from the results in Table 4 above, the amylase and protease activities of the rice koji prepared using novel Aspergillus oryzae CJ 1354 were higher by 17.1% and 11.8%, respectively, than those of the rice koji prepared using conventional Aspergillus oryzae.

3) First Aging

Using the rice kojis of Example 2 and Comparative Example 2, first mixtures were prepared as described in Example 3 and Comparative Example 3 below. Then, the mixtures were aged at 30° C. for 15-30 days.

### Example 3: Preparation of First Mixture Using Novel Aspergillus oryzae CJ 1354

Based on the total weight of a first mixture, 15-25 wt % of salt water (30° C.), and 3-15 wt % of powder obtained by simply powdering commercial beans, commercial meju (obtained by fermenting beans alone or a mixture of beans and a starchy material by an improved or conventional method) and doenjang, were added to the rice koji prepared in Example 2, and 5-15 wt % of steamed rice was added thereto and mixed therewith, thereby preparing a first mixture having a water content of 45 wt %.

### Comparative Example 3: Preparation of First Mixture Using Conventional Aspergillus oryzae

Based on the total weight of a first mixture, 15-25 wt % of salt water (30° C.), and 3-15 wt % of powder obtained by simply powdering commercial beans, commercial meju (obtained by fermenting beans alone or a mixture of beans and a starchy material by an improved or conventional method) and doenjang, were added to the rice koji prepared in Comparative Example 2, and 5-15 wt % of steamed rice was added thereto and mixed therewith, thereby preparing a first mixture having a water content of 45 wt %.

4) Second Aging

Using the first mixtures of Example 3 and Comparative Example 3, subjected to the first aging step, second mixtures were prepared as described in Examples 4 and Comparative Example 4 below. The second mixtures were sterilized and aged, thereby preparing rice hot pepper pastes.

In addition, the amino acids and fragrant components of the prepared hot pepper pastes were compared.

### Example 4: Preparation of Second Mixture Using Novel Aspergillus oryzae CJ 1354

Based on the total weight of a second mixture, 6-25 wt % of commercial hot pepper powder, 10-15 wt % of minced spice, 15-25 wt % of starch sugar, 0.05-0.1 wt % of a flavor enhancer (bean protein extract), 0.2-1 wt % of soy sauce and 0.5-1 wt % of salt were added to and mixed with the first mixture of Example 3, aged for 15-30 days in the first aging. Next, the resulting mixture was sterilized at 70° C. for 15 minutes, and then 1-2 wt % of edible alcohol was added thereto, followed by aging.

The amino acid contents of the rice hot pepper paste prepared using novel Aspergillus oryzae CJ 1354 are shown in Table 5 below.

The fragrant components of the rice hot pepper paste prepared using novel Aspergillus oryzae CJ 1354 are shown in Table 6 below.

### Comparative Example 4: Preparation of Second Mixture Using Conventional Aspergillus oryzae

Based on the total weight of a second mixture, 6-25 wt % of commercial hot pepper powder, 10-15 wt % of minced spice, 15-25 wt % of starch sugar, 0.05-0.1 wt % of a flavor enhancer (bean protein extract), 0.2-1 wt % of soy sauce and 0.5-1 wt % of salt were added to and mixed with the first mixture of Comparative Example 3, aged for 15-30 days in the first aging step. Next, the resulting mixture was sterilized at 70° C. for 15 minutes, and then 1-2 wt % of edible alcohol was added thereto, followed by aging.

The amino acid contents of the rice hot pepper paste prepared using conventional Aspergillus oryzae are shown in Table 5 below.

The fragrant components of the rice hot pepper paste prepared using conventional Aspergillus oryzae are shown in Table 6 below.

TABLE 5
Analysis of amino acid contents of rice hot pepper pastes
(unit: pmol/uL)

| Amino acids | Comparative Example 4 | Example 4 | p-value |
|---|---|---|---|
| aspartate | 4814.8^{a)} | 4763.4^{a)} | 0.659 |
| glutamate | 5920.5^{a)} | 5723.1^{a)} | 0.274 |
| asparagine | 8581.2^{a)} | 8411.1^{a)} | 0.487 |
| serine | 3238.1^{a)} | 3145.7^{a)} | 0.324 |
| glutamine | 2726.4^{a)} | 2278.0^{b)} | 0.002 |
| histidine | 729.4^{a)} | 587.2^{b)} | 0.001 |
| glycin | 2490.5^{a)} | 2529.0^{a)} | 0.553 |
| threonine | 2290.8^{a)} | 2253.4^{a)} | 0.512 |
| arginine | 4006.5^{a)} | 3954.2^{a)} | 0.653 |
| alanine | 4797.8^{a)} | 4765.7^{a)} | 0.817 |
| GABA | 1919.1^{a)} | 1971.0^{a)} | 0.485 |
| tyrosine | 1516.6^{a)} | 1417.2^{b)} | 0.043 |
| valine | 2831.9^{a)} | 2739.4^{a)} | 0.25 |
| methionine | 752.5^{a)} | 632.7^{b)} | 0.01 |
| tryptophan | 369.8^{a)} | 325.8^{b)} | 0.022 |
| phenylalanine | 1962.6^{a)} | 1790.9^{b)} | 0.027 |
| isoleucine | 1894.2^{a)} | 1798.1^{a)} | 0.131 |
| leucine | 3220.7^{a)} | 2948.6^{b)} | 0.024 |
| lysine | 2426.6^{a)} | 2248.6^{a)} | 0.288 |
| proline | 8621.7^{a)} | 8622.4^{a)} | 0.997 |

*not significantly different between the same superscripts (p < 0.05)

As can be seen from the results in Table 5 above, the contents of bitter-taste amino acids (tyrosine, valine, tryptophan, phenylalanine, and leucine) having a hydrophobic side chain in the amino acid composition of Example 4 were significantly lower than those in the amino acid composition of Comparative Example 4.

TABLE 6
Major fragrant components of rice hot pepper pastes
(unit: peak area %)

| Major fragrant | Comparative | Example |
|---|---|---|
| components | Example 4 | 4 |
| 3-methyl | 0.09 ± 0.02 | 0.14 ± 0.01 |
| butanoic acid | | |
| hexanal | 0.19 ± 0.03 | 0.15 ± 0.06 |
| benzaldehyde | 0.26 ± 0.02 | 0.22 ± 0.01 |
| 1-hexanol | 0.07 ± 0.01 | 0.06 ± 0.01 |
| 1-octen-3-ol | — | 0.06 ± 0.00 |
| benzeneethanol | 0.31 ± 0.05 | 0.44 ± 0.04 |
| ethyl acetate | 0.42 ± 0.08 | 0.47 ± 0.04 |
| 2-pentyl furan | 0.98 ± 0.16 | 0.94 ± 0.14 |
| beta-ionone | 0.06 ± 0.01 | 0.05 ± 0.01 |
| 2-methoxy phenol | 0.02 ± 0.00 | — |
| phenol | 0.01 ± 0.00 | — |
| 2-methoxy- | 0.23 ± 0.04 | 0.22 ± 0.02 |
| 4-vinylphenol | | |
| 3-(methylthio)-1- | 0.18 ± 0.01 | 0.14 ± 0.01 |
| propene(allyl methyl sulfide) | | |

As can be seen from the results in Table 6 above, the content of phenol compounds (2-methoxy phenol, phenol, and 2-methoxy-4-vinylphenol) that can smell nasty was lower in the hot pepper paste of Example 4 than in the hot pepper paste of Comparative Example 4. In addition, the content of esters (such as ethyl acetate) that emit sweet and fruity fragrance to enhance the overall fragrance was higher in the hot pepper paste of Example 4 than in the hot pepper paste of Comparative Example 4.

3. Sensory Evaluation of Hot Pepper Pastes

For the rice hot pepper paste (Comparative Example 4) prepared using conventional Aspergillus oryzae and the rice hot pepper paste (Example 4) prepared using novel Aspergillus oryzae CJ 1354, the sensory evaluation of the rice hot pepper pastes was performed by sixty-eight 25-55-year old housewives who lived in Seoul and Gyeonggi-do, Korea. In the sensory evaluation, the taste properties of the rice hot pepper pastes were evaluated on a five-point scale, and the overall taste was evaluated by preference.

The results of the sensory evaluation are shown in Tables 7 and 8 below.

In addition, descriptive analysis was performed by 10 trained panelists. The evaluation was repeated three times, and the results were averaged.

The results of the descriptive analysis are shown in Table 7 below.

TABLE 7
Sensory evaluation of rice hot pepper
pastes (preference, 5-point scale)

| | Comparative | Example | p- |
|---|---|---|---|
| Taste properties | Example 4 | 4 | value |
| Appearance | 4.03 | 4.06 | 0.81 |
| Fragrance | 3.37 | 3.54 | 0.16 |
| Texture (physical property | 3.69 | 3.81 | 0.40 |
| and mouth feeling) | | | |
| Aftertaste | 3.26 | 3.26 | 1.00 |
| Hot taste | 3.79 | 3.74 | 0.70 |
| Salty taste | 3.26 | 3.37 | 0.49 |
| Sweet taste | 3.31 | 3.44 | 0.37 |
| Palatable taste | 3.40 | 3.46 | 0.71 |
| Thick taste | 3.85 | 3.82 | 0.84 |

TABLE 8
Investigation of preference of rice hot pepper pastes

| | Comparative | | |
|---|---|---|---|
| | Example 4 | Example 4 | No difference |
| Preference (%) | 38.2 | 52.9 | 8.8 |

TABLE 9
Descriptive analysis of rice hot pepper pasts (15-point scale)

| | | Comparative | Example | p- |
|---|---|---|---|---|
| Properties | | Example 4 | 4 | value |
| Taste/ | Sweet taste | 6.20 | 8.50 | 0.000 |
| Flavor | | | | |
| | Salty taste | 8.20 | 7.23 | 0.000 |
| | Bitter taste | 4.73 | 3.27 | 0.000 |
| | Sour taste | 3.90 | 5.00 | 0.000 |
| | Umami | 5.43 | 7.03 | 0.000 |
| | Meju flavor | 3.23 | 2.23 | 0.000 |
| | Hot flavor | 8.73 | 7.73 | 0.000 |
| | Hot pepper odor | 6.57 | 4.67 | 0.000 |
| | Hot pepper | 8.40 | 6.60 | 0.000 |
| | powder flavor | | | |
| | Wheat flour flavor | 3.30 | 4.37 | 0.000 |
| | Glutinous rice flavor | 1.33 | 1.40 | 0.766 |
| | Molasses flavor | 4.43 | 5.93 | 0.000 |
| | Garlic stem flavor | 3.40 | 1.07 | 0.000 |

As can be seen from the results in Tables 7, 8 and 9 above, the preference of texture (physical properties and mouth feeling) was higher in the rice hot pepper paste of Example 4 than in the rice hot pepper paste of Comparative Example 4. This is because the rice was milled to have a whiteness of 35 in order to enhance the texture of hot pepper paste.

The rice hot pepper paste of Example 4 showed relatively high values in terms of umami, sweet taste, sour taste and the like, and low values in terms of sour taste and the like.

This is believed to be because the use of novel Aspergillus oryzae CJ 1354 having high amylase and protease activities enhanced the degradation of rice and provided good-quality degradation products.

As described above, according to the present invention, novel Aspergillus oryzae CJ 1354, which exhibits high carbohydrase and protease activities in rice as a substrate, was isolated and identified from Korean traditional meju. Using the isolated novel Aspergillus oryzae CJ 1354, rice hot pepper paste having a better flavor can be prepared.

In addition, the method for preparing rice hot pepper paste according to the present invention comprises the process in which rice milled to have a certain whiteness is treated with high-pressure steam having a pressure of 2.0-4.0 kgf/cm² in the steaming step. This process has the effect of controlling the viscosity and water content of the steamed rice, thereby preventing the raw material from agglomerating during transfer.

1-9. (canceled)

10. A rice hot pepper paste comprising rice koji prepared by inoculating and culturing Aspergillus oryzae CJ 1354 deposited under the deposition number of KCCM 11300P in the steamed rice or Aspergillus oryzae CJ 1354 deposited under the deposition number of KCCM 11300P isolated and identified from Korean traditional meju.

11. The rice hot pepper paste of claim 10, wherein the Aspergillus oryzae CJ 1354 has the activity of reducing the content of one or more amino acids selected from tyrosine, valine, tryptophan, phenylalanine and leucine, in the rice hot pepper paste.

12. The rice hot pepper paste of claim 10, wherein the Aspergillus oryzae CJ 1354 has the activity of reducing the content of one or more phenol compounds selected from 2-methoxy phenol, phenol and 2-methoxy-4-vinylphenol, in the rice hot pepper paste.

13. The rice hot pepper paste of claim 10, wherein the Aspergillus oryzae CJ 1354 has the activity of increasing the content of ethyl acetate in the rice hot pepper paste.

14. The rice hot pepper paste of claim 10, wherein the Aspergillus oryzae CJ 1354 has high amylase and protease activities in rice as a substrate.

15. The rice hot pepper paste of claim 10, wherein the Aspergillus oryzae CJ 1354 has high spore-producing ability in the rice hot pepper paste.

16. The rice hot pepper paste of claim 10, wherein the Aspergillus oryzae CJ 1354 produces no toxin and causes no allergy.

17. A rice koji prepared by inoculating and culturing Aspergillus oryzae CJ 1354 deposited under the deposition number of KCCM 11300P in the steamed rice.

18. A method for preparing a rice hot pepper paste, the method comprising the steps of:
(1) soaking rice in water or adding water to rice, and steaming the soaked or water-added rice;
(2) inoculating and culturing Aspergillus oryzae CJ 1354 in the steamed rice to make rice koji;
(3) adding salt water to the rice koji, mixing therewith at least one selected from the group consisting of steamed rice, a processed bean product, Korean traditional meju and Korean traditional doenjang, to obtain a first mixture, and aging the first mixture; and
(4) adding hot pepper powder to the aged first mixture, mixing therewith at least one selected from the group consisting of starch sugar, soy sauce, a spice product, a flavor enhancer and a processed grain product, to obtain a second mixture, and aging the second mixture.

19. The method of claim 18, wherein the rice used in step (1) has a whiteness of 28-45.

20. The method of claim 18, wherein the rice steamed in step (1) has a water content of 25-35 wt %.

21. The method of claim 18, wherein step (3) comprises adding to the steamed rice, based on the weight of the steamed rice, 0.1-0.3 wt % of Aspergillus oryzae CJ 1354 and 0.5-1.5 wt % of a bulking agent, followed by fermentation at a temperature between 33° C. and 40° C. for 3 days to make rice koji.

22. The method of claim 18, wherein step (3) comprises adding to the rice koji, based on the total weight of the first mixture, 15-25 wt % of salt water, 5-15 wt % of steamed rice and 3-15 wt % of one or more selected from among a processed bean product, meju and doenjang, followed by fermentation at a temperature between 25° C. and 35° C. for 15-30 days.

23. The method of claim 18, wherein step (4) comprises adding to the aged first mixture, based on the total weight of the second mixture, 6-25 wt % of hot pepper powder, and 15-40 wt % of one or more selected from the group consisting of starch sugar, soy sauce, salt, a spice product, a flavor enhancer and a processed grain product, to obtain the second mixture, sterilizing the second mixture at a temperature between 55° C. and 85° C. for 1-60 minutes, and adding edible alcohol to the sterilized second mixture, followed by aging.


SEQUENCE LISTING (1 sequence)

SEQ ID NO: 1 - DNA, 369 bp, Aspergillus oryzae CJ 1354
actctgtctgatctagtgaagtctgagttgattgtatcgcaatcagttaaaactttcaacaatggatctcttggttccggcatcgatgaagaacgcagcgaaatgcgataactagtgtgaattgcagaattccgtgaatcatcgagtctttgaacgcacattgcgccccctggtattccggggggcatgcctgtccgagcgtcattgctgcccatcaagcacggcttgtgtgttgggtcgtcgtcccctctccgggggggacgggccccaaaggcagcggcggcaccgcgtccgatcctcgagcgtatggggctttgtcacccgctctgtaggcccggccggcgcttgccgaacgcaaatcaatctttt